(19) United States
(12) Patent Application Publication
(10) Pub. No.: US 2005/0196695 A1
(43) Pub. Date: Sep. 8, 2005

(54) Toner

(75) Inventors: Masahiko Kubo, Nara-shi (JP); Satoshi Ogawa, Nara-shi (JP); Yoshiaki Akazawa, Nara-shi (JP); Hiromi Nakatsu, Amagasaki-shi (JP); Akio Matsumoto, Nara-shi (JP); Masao Suzuki, Yamatokoriyama-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/069,591

(22) Filed: Mar. 2, 2005

(30) Foreign Application Priority Data
Mar. 3, 2004 (JP) P2004-059538

(51) Int. Cl. G03G 9/08

(52) U.S. Cl. 430/108.6; 430/108.7

(57) ABSTRACT

A toner is provided with which the image formed by the use of an image-forming apparatus for electrophotography may keep a good and uniform image density for a long period of time from the initial stage of image formation. The toner contains a toner base particle containing at least a colorant and a binder resin, silica having an average particle size of 40 nm or larger and 200 nm or smaller, and an aluminum oxide-silicon dioxide mixed oxide having an average particle size of 5 nm or larger and 25 nm or smaller. The silica and the aluminum oxide-silicon dioxide mixed oxide are externally added to the toner base particle.

### BACKGROUND OF THE INVENTION

1. Field of the Invention

The present invention relates to a toner used in image-forming apparatus for electrophotography such as electrostatic duplicators and laser beam printers.

2. Description of the Related Art

Recently, image-forming apparatus for electrophotography such as electrostatic duplicators and laser beam printers, especially those for full-color printing have been becoming much popular.

The image-forming apparatus for electrophotography is an apparatus for forming an image on a recording medium in a process comprising a charging step, an exposure step, a development step, a transfer step and a fixation step. In the charging step, the surface of a photoreceptor is uniformly charged. In the exposure step, the charged photoreceptor is exposed to light to thereby form an electrostatic latent image on the surface thereof. In the development step, a developing agent is adhered to the electrostatic latent image formed on the surface of the photoreceptor to thereby form a visible image. In the transfer step, the visible image formed on the surface of the photoreceptor is transferred onto a recording medium such as paper or sheet. In the fixation step, the visible image transferred onto the recording medium is fixed thereon by means for heating and pressing it. According to the process comprising the steps as above, the image-forming apparatus for electrophotography makes it possible to form a desired image on a recording medium.

In general, full-color printing in the image-forming apparatus for electrophotography is realized by a developing agent that comprises three primary color toners of yellow, magenta and cyan, or four color toners of the three color toners and a black toner added thereto. Specifically, in the apparatus, the process of the charging step, the exposure step, the development step and the transfer step is repeated for every color toner to thereby form a visible image of plural color toners on a recording medium; and in the fixation step, the toners are fused and mixed for color mixing whereby the visible image is fixed on the recording medium to be a full-color image thereon.

As the developing agent, known are a two-component developing agent comprising a carrier and a toner, and a one-component developing agent comprising a toner alone. The one-component developing agent is advantageous in that the size, the weight and the cost of the apparatus may be reduced. In full-color printing, a non-magnetic developing agent not containing a colored magnetic substance must be used. Accordingly, a non-magnetic one-component developing agent is preferably used for full-color image-forming apparatus.

The development step for the image-forming apparatus where a non-magnetic one-component developing agent is used includes a feeding step of feeding a toner onto a development roller by pressing a feeding roller against the development roller; a thin film-forming step of forming a thin layer of the toner on the development roller by electrostatically holding the toner on the development roller followed by pressing a layer thickness-controlling member against the toner; and a charge-imparting step of imparting a charge to the toner by pressing the layer thickness-controlling member against the toner in forming the thin layer of the toner.

For obtaining high-quality images by repeating these steps, it is desired that a uniformly charged toner is stably fed from the feeding roller to the development roller so as to form a uniform thin layer of the toner on the development roller, and the toner is so designed that properties of the toner are prevented from being deteriorated, especially the condition of an external additive existing on the toner surface is prevented from being changed owing to the pressure contact of the layer thickness-controlling member against the toner.

Heretofore, a toner has been proposed, to which silica having a small particle size and silica having a large particle size are externally added. In a black toner of the type comprising carbon black, the silica having a small particle size imparts flowability to the toner, and the silica having a large particle size acts to prevent the external additive from being buried in the toner. Accordingly, the toner has good flowability and long-term stability. However, a color toner containing an organic pigment naturally has a high surface resistivity, and when silica having a high surface resistivity is externally added to the toner, then the toner may have some negative influence on the image formation with the toner since the surface resistivity of the toner is kept high. In other words, the charge transfer could not be smoothly attained along with the toner transfer, and in toner feeding from a feeding roller to a development roller, the balance of an amount between toner scraping and toner feeding is lost. As a result, stable and uniform toner feeding to a development roller could not be attained, and the amount of the toner adhered to the formed image is often uneven.

Accordingly, the properties that the toner to be used in an image-forming apparatus for electrophotography are desired to have are that not only the toner has good flowability and may prevent the external additive from being buried in the toner but also the toner has a suitable surface resistivity and has good long-term stability. For producing a toner having a suitable surface resistivity and having good long-term stability, an external additive to be adhered to the toner surface is now under investigation.

A typical related technique is described in Japanese Unexamined Patent Publication JP-A 2002-296830. The toner described in JP-A2002-296830 contains a binder resin, a colorant and an external additive, in which the external additive comprises silica (silicon dioxide) having an average particle size of smaller than 20 nm, silica having an average particle size of at least 20 nm, and alumina (aluminum oxide) having an average particle size of at least 1 μm.

Another related technique similar to the technique described in JP-A 2002-296830 is described in Japanese Unexamined Patent Publication JP-A 2002-351133. The toner for development of electrostatically-charged images of JP-A 2002-351133 contains, as an external additive, fine particles of silica having a primary average particle size of 15 nm, large-size silica particles having a primary average particle size of 40 nm and titanium oxide having a primary average particle size of 15 nm.

Still another related technique is described in Japanese Unexamined Patent Publication JP-A 2001-83731. The dry-type developing agent for development of electrostatically-charged images of JP-A 2001-83731 contains toner particles that contain a binder resin and a colorant, and, as a fluidizing agent (external additive), an amorphous silicon-aluminum co-oxide fine powder in which Al₂O₃ and SiO₂ are mixed in a predetermined blend ratio, or an amorphous silicon-titanium in which TiO₂ and SiO₂ are mixed in a predetermined blend ratio.

Still another related technique similar to the technique in JP-A 2001-83731 is described in Japanese Unexamined Patent Publication JP-A 2003-57871. The dry-type toner of JP-A 2003-57871 contains, as an external additive, aluminum oxide-silicon dioxide mixed oxide particles and small-size silica particles both in a predetermined amount relative to the toner base particles.

A toner must have suitable flowability and chargeability so that the toner may smoothly adhere to the electrostatic latent image formed on the surface of a photoreceptor, and also a color toner must have suitable surface resistivity and must keep properties as such for a long period of time. Toner particles may have good properties and may keep the properties as such for a long period of time, depending on the external additive and an added amount of the external additive.

The toner disclosed in JP-A 2002-296830 contains, externally added thereto, silica having an average particle size of smaller than 20 nm, and the silica ensures the flowability of the toner. It further contains, also externally added thereto, silica having an average particle size of at least 20 nm, and the silica acts to prevent the external additive from being buried in the toner particles. However, when silica alone is added as an external additive to a toner, then the surface resistivity of the toner is kept still high since the surface resistivity of silica is high. Therefore, alumina having a low surface resistivity is added to the toner, in which the alumina serves as a resistivity-controlling agent and makes the toner have a suitable surface resistivity. Accordingly, the toner may have good properties such as suitable flowability and surface resistivity, and may keep the properties as such for a long period of time. However, the silica having an average particle size of smaller than 20 nm may cover the alumina and the toner, and it may interfere with the function of the alumina serving as a resistivity-controlling agent. Accordingly, a black toner of the type that comprises carbon black having a low surface resistivity as the colorant may attain stable development, but a color toner could not be uniformly fed since the color toner has a high surface resistivity.

The toner for development of electrostatically-charged images disclosed in JP-A 2002-351133 contains, as an external additive, fine particles of silica having a primary average particle size of 15 nm, large-size silica particles having a primary average particle size of 40 nm and titanium oxide having a primary average particle size of 15 nm. Thus, the fine silica particles impart flowability to the toner, and the large-size silica particles act to prevent the external additive from being buried in the toner, and, in addition, the titanium oxide having a low surface resistivity acts as a surface-resisting agent and controls the surface resistivity of the toner. However, the fine silica particles may cover the titanium oxide and the toner and may interfere with the function of the titanium oxide that serves as a resistivity-controlling agent, and therefore, the surface resistivity of the toner is still kept high.

The dry-type developing agent for development of electrostatically-charged images disclosed in JP-A 2001-83731 contains, as a fluidizing agent (external additive), an amorphous silicon-aluminum co-oxide fine powder in which Al₂O₃ and SiO₂ are mixed in a predetermined blend ratio, or an amorphous silicon-titanium in which TiO₂ and SiO₂ are mixed in a predetermined blend ratio. Therefore, the amorphous silicon-aluminum co-oxide fine powder or the amorphous silicon-titanium ensures the flowability, serves as a resistivity-controlling agent, accordingly, may have suitable surface resistivity and flowability, and may ensure excellent stable feeding. However, since large-size particles capable of preventing the external additive from being buried are not added, the developing agent may be deteriorated after used for a long period of time.

The dry-type toner disclosed in JP-A 2003-57871 contains, as particles for external addition (external additive), aluminum oxide-silicon dioxide mixed oxide particles, like the dry-type developing agent for development of electrostatically-charged images disclosed in JP-A2001-83731. Therefore, the toner as a developing agent may have suitable surface resistivity and flowability and may ensure excellent stable feeding. Further, the toner contains small-size silica particles having an average particle size of 12 nm, but the average particle size of the silica particles therein is too small and the particles could not act to prevent the external additive from being buried in the toner. Therefore, the toner lacks long-term stability.

### SUMMARY OF THE INVENTION

An object of the invention is to provide a toner which, when used in an image-forming apparatus for electrophotography, may form a good image having a uniform image density continuously for a long period of time from the initial stage of image formation.

The invention provides a toner comprising:
a toner base particle containing at least a colorant and a binder resin;
silica having an average particle size of from 40 nm to 200 nm; and
an aluminum oxide-silicon dioxide mixed oxide having an average particle size of from 5 nm to 25 nm,
wherein the silica and the aluminum oxide-silicon dioxide mixed oxide are externally added to the toner base particle.

In the invention, the aluminum oxide-silicon dioxide mixed oxide is prepared according to a thermal decomposition method.

In the invention, the aluminum oxide-silicon dioxide mixed oxide is externally added to the toner base particle so that an amount of the aluminum oxide-silicon dioxide mixed oxide is from 0.1 parts by weight to 2 parts by weight relative to 100 parts by weight of the toner base particle.

In the invention, the silica is externally added to the toner base particle so that an amount of the silica is from 0.5 parts by weight to 3 parts by weight relative to 100 parts by weight of the toner base particle.

In the invention, the proportion of aluminum oxide in the aluminum oxide-silicon dioxide mixed oxide is from 50% to 70%.

According to the invention, silica having an average particle size of from 40 nm to 200 nm and an aluminum oxide-silicon dioxide mixed oxide having an average particle size of from 5 nm to 25 nm are added, as an external additive, to toner base particle that contains at least a colorant and a binder resin.

Externally adding the aluminum oxide-silicon dioxide mixed oxide having an average particle size of from 5 nm to 25 nm realizes a toner having suitable flowability and surface resistivity. The aluminum oxide-silicon dioxide mixed oxide is a mixed oxide that comprises silicon dioxide, a component capable of increasing flowability but also increasing surface resistivity, and aluminum oxide, a component capable of lowering surface resistivity. In other words, the aluminum oxide-silicon dioxide mixed oxide is a resistivity-controlling agent capable of controlling surface resistivity and increasing flowability. When being externally added to a toner, the aluminum oxide-silicon dioxide mixed oxide may impart suitable flowability and surface resistivity to the toner. Further, silica having an average particle size of from 40 nm to 200 nm is externally added to the toner base particle, whereby the external additive is prevented from being buried in the toner base particle and the toner may have good long-term stability.

Accordingly, the toner of the invention has suitable flowability and surface resistivity and has good long-term stability. When the toner is used for image formation, the toner may form a good image having a uniform image density continuously for a long period of time from the initial stage of image formation.

According to the invention, the aluminum oxide-silicon dioxide mixed oxide is prepared according to a thermal decomposition method, and therefore, the aluminum oxide-silicon dioxide mixed oxide may have a desired particle size. Accordingly, the toner which may have more suitable flowability and surface resistivity can be obtained. Using the toner makes it possible to form better images.

According to the invention, the aluminum oxide-silicon dioxide mixed oxide is externally added to the toner base particle so that an amount of the aluminum oxide-silicon dioxide mixed oxide is from 0.1 parts by weight to 2 parts by weight relative to 100 parts by weight of the toner base particle. Therefore, the toner which may sufficiently exhibit the function of the aluminum oxide-silicon dioxide mixed oxide therein, and which may have more suitable flowability and surface resistivity can be obtained. Using the toner makes it possible to form better images.

According to the invention, the silica is externally added to the toner base particle so that an amount of the silica is from 0.5 parts by weight to 3 parts by weight relative to 100 parts by weight of the toner base particle. Therefore, the toner which may have good long-term stability can be obtained. Using the toner makes it possible to form better images for a long period of time.

According to the invention, the proportion of aluminum oxide in the aluminum oxide-silicon dioxide mixed oxide is from 50% to 70%. Therefore, the toner which may sufficiently exhibit the function of the aluminum oxide-silicon dioxide mixed oxide therein, and which may have more suitable flowability and surface resistivity can be obtained. Using the toner makes it possible to form better images.

### BRIEF DESCRIPTION OF THE DRAWING

Other and further objects, features, and advantages of the invention will be more explicit from the following detailed description taken with reference to the drawings wherein:

FIG. 1 is a schematic cross-sectional view graphically showing the constitution of the toner of an embodiment of the invention.

### DETAILED DESCRIPTION OF THE PREFERRED EMBODIMENTS

Now referring to the drawings, preferred embodiments of the invention are described below.

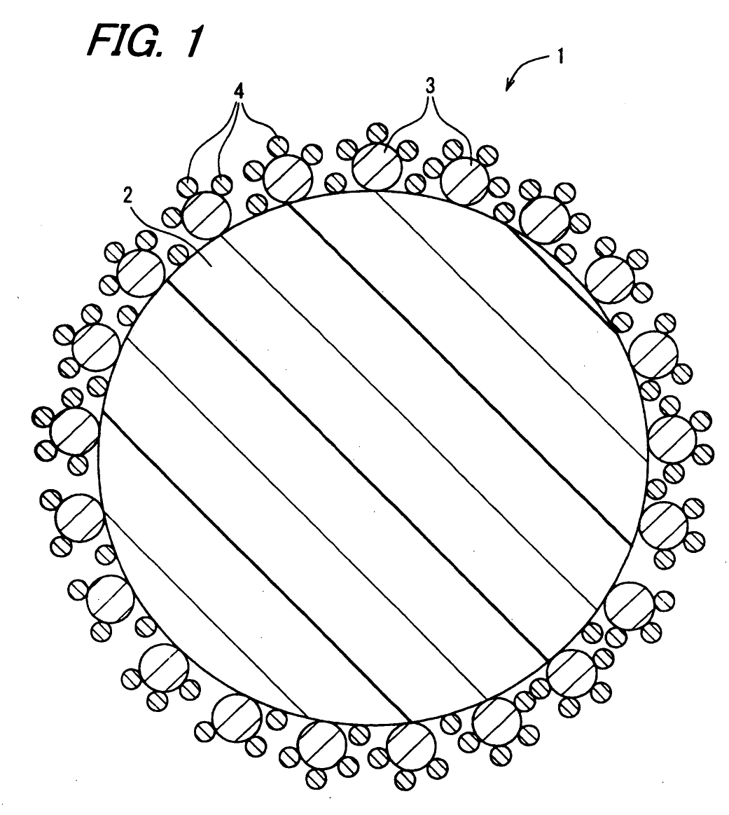

FIG. 1 is a schematic cross-sectional view showing the constitution of a toner 1 of an embodiment of the invention. As in FIG. 1, the toner 1 comprises a toner base particle 2, silica 3 and aluminum oxide-silicon dioxide mixed oxide 4.

External Additive:

Silica and aluminum oxide-silicon dioxide mixed oxide are used as the external additive to be adhered to the toner base particles so as to control the flowability and the chargeability and also control surface resistivity, and the external additive are prevented from being buried in the particles.

Silica:

A toner of an embodiment of the invention contains silica as the external additive. Preferably, the average particle size of the silica is from 40 nm to 200 nm. The silica adheres to the surface of the toner base particles, and the external additive is therefore prevented from being buried in the toner. Further, since the toner base particles are not indirect contact with each other, the toner base particles are prevented from aggregating together. Specifically, the external additive of silica has a spacer effect to protect the toner from being deteriorated owing to some external pressure such as the pressure by a layer thickness-controlling member pressed against the toner, and therefore, the toner may have long-term stability. However, when the average particle size of the silica are smaller than 40 nm, the silica may be ineffective for preventing the external additive from being buried in the toner ; but when the size is larger than 200 nm, such large silica particles could hardly adhere to the toner base particles, in addition, may readily drop away from the toner base particles and, as a result, could not ensure the spacer effect of silica. Thus, the long-term stability of the toner may worsen. More preferably, silica is processed for hydrophobication. The hydrophobication treatment may be effected in any known manner, and for example, silica may be reacted with a trimethylsilyl group-having compound.

Preferably, silica is externally added to the toner base particles in an amount of from 0.5 parts by weight to 3 parts by weight relative to 100 parts by weight of the base particles. When the amount is smaller than 0.5 parts by weight, then the external additive could not be satisfactorily prevented from being buried in the toner and the long-term stability of the toner may be poor; but when larger than 3 parts by weight, then the flowability of the toner may worsen and the toner could not be stably fed.

Aluminum Oxide-Silicon Dioxide Mixed Oxide:

The toner of an embodiment of the invention contains aluminum oxide-silicon dioxide mixed oxide as the external additive. Preferably, the average particle size of the aluminum oxide-silicon dioxide mixed oxide is from 5 nm to 25 nm. Externally added to the toner base particle, aluminum oxide-silicon dioxide mixed oxide may impart suitable flowability and chargeability to the toner. However, when the size of the mixed oxide is smaller than 5 nm, many particles of the mixed oxide may adhere to the toner as aggregates and the adhering condition of the particles could not be uniform. As a result, the surface resistivity of the toner may fluctuate and the toner could not be uniformly fed and could not be uniformly charged, and the image formed of the toner may be worsened. When the size is larger than 25 nm, the surface resistivity of the toner could not be suitably controlled. The aluminum oxide-silicon dioxide mixed oxide may be produced in any mode of a vapor-phase process or a wet process. Regarding the vapor-phase process, when the thermal decomposition method described in Japanese Unexamined Patent Publication JP-A 2000-181130 is employed for producing the mixed oxide, it is more desirable as giving aluminum oxide-silicon dioxide mixed oxide having a desired particle size.

Preferably, the proportion of aluminum oxide in the aluminum oxide-silicon dioxide mixed oxide is from 50% to 70%. Aluminum oxide-silicon dioxide mixed oxide may increase the flowability of the toner, but it is a mixed oxide that comprises silicon dioxide serving as a component for increasing the surface resistivity of toner and aluminum oxide serving as a component for lowering the surface resistivity. Accordingly, externally adding the aluminum oxide-silicon dioxide mixed oxide to toner base particle makes it possible to increase the flowability of the toner not increasing the surface resistivity. However, when the proportion of aluminum oxide in the aluminum oxide-silicon dioxide mixed oxide is smaller than 50%, the surface resistivity of the toner may be too high and the toner could not uniformly move, so that an uneven image may be formed; but when the proportion is larger than 70%, then the toner could not have satisfactory flowability and could not move uniformly.

Preferably, the amount of the aluminum oxide-silicon dioxide mixed oxide to be externally added to the toner base particle is from 0.1 parts by weight to 2 parts by weight relative to 100 parts by weight of the toner base particles, more preferably from 0.5 parts by weight to 2 parts by weight. When the amount is smaller than 0.1 parts by weight, the toner could not ensure suitable flowability and, in addition, the surface resistivity could not be controlled. When the amount is larger than 2 parts by weight, then the external additive could hardly adhere to the toner base particles.

Toner Base Particles:

The toner base particles are constituted so as to contain a colorant, a binder resin and a charge-controlling agent. Preferably, the toner base particles have an average particle size of from 3 μm to 30 μm, more preferably from 4 μm to 9 μm, even more preferably from 5 μm to 8 μm.

Colorant:

The toner of an embodiment of the invention contains a colorant in the toner base particles. The colorant may be any known black colorant or color colorant. The color of the colorant may be suitably selected so that a toner of a desired color can be realized. For example, when a black toner is produced, a black colorant is used; but when a color toner is produced, a color colorant corresponding to each color is used.

For the colorant for black (B) toner, various types of carbon black that are classified according to the production method for them are preferably used. Concretely, for example, there are mentioned furnace black, channel black, acetylene black, thermal black and lamp black.

The colorant for yellow (Y) toner includes, for example, pigments that are classified according to Color Index (abbreviation, C.I.) Number, C.I. Pigment Yellow 1, C.I. Pigment Yellow 5, C.I. Pigment Yellow 12, C.I. Pigment Yellow 15, C.I. Pigment Yellow 17, C.I. Pigment Yellow 180, C.I. Pigment Yellow 93, C.I. Pigment Yellow 74; and inorganic pigments such as yellow iron oxide, Chinese yellow. The dye for the yellow (Y) toner includes, for example, nitro dyes such as C.I. Acid Yellow 1; and oil-soluble dyes such as C.I. Solvent Yellow 2, C. I. Solvent Yellow 6, C.I. Solvent Yellow 14, C.I. Solvent Yellow 15, C.I. Solvent Yellow 19, and C.I. Solvent Yellow 21.

The colorant for magenta (M) toner includes, for example, C.I. Pigment Red 49, C.I. Pigment Red 57, C.I. Pigment Red 81, C.I. Pigment Red 122, C.I. Solvent Red 19, C.I. Solvent Red 49, C.I. Solvent Red 52, C.I. Basic Red 10, and C.I. Disperse Red 15.

The colorant for cyan (C) toner includes, for example, C.I. Pigment Blue 15, C.I. Pigment Blue 16, C.I. Solvent Blue 55, C.I. Solvent Blue 70, C.I. Direct Blue 25, and C.I. Direct Blue 86.

Preferably, the content of the colorant is from 1 part by weight to 30 parts by weight relative to 100 parts by weight of the binder resin, more preferably from 2 parts by weight to 20 parts by weight. When it is smaller than 1 part by weight, then a desired image density could not be obtained and when larger than 30 parts by weight, the colorant could not dispersed in the binder resin.

Binder Resin:

The toner of an embodiment of the invention is constituted so as to contain a binder resin in the toner base particles. The binder resin may be any known resin, including, for example, polyester resin, styrene-acrylic resin, epoxy resin and polyurethane resin. Of those, preferred is polyester resin.

The polyester resin may be obtained in any known method. Concretely, it may be obtained through polycondensation of a polyalcohol component and a polycarboxylic acid component. The polyalcohol component may be a dialcohol such as ethylene glycol, 1,2-propylene glycol, 1,3-propylene glycol, 1,4-butanediol, 2,3-butanediol, diethylene glycol, triethylene glycol, 1,5-pentanediol, 1,6-hexanediol, neopentylene glycol, 1,4-cyclohexanedimethanol, dipropylene glycol, polyethylene glycol, polypropylene glycol, bisphenol A, and hydrogenated bisphenol A, as well as bisphenol A-alkylene oxide adducts such as polyoxyethylenated bisphenol A and polyoxypropylenated bisphenol A. A tri or more polyalcohol may also be used for non-linearizing (crosslinking) the polymer to such a degree that it does not give tetrahydrofuran insolubles. The tri or more polyalcohol component includes glycerin, sorbitol, 1,2,3,6-hexanetetraol, 1,4-sorbitan, pentaerythritol, 1,2,4-butanetriol, 1,2,5-pentanetriol, 2-methylpropanetriol, 2-methyl-1,2,4-butanetriol, trimethylolethane, trimethylolpropane, and 1,3,5-trihydroxymethylbenzene.

Charge-Controlling Agent:

The toner of an embodiment of the invention is constituted so as to contain a charge-controlling agent in the toner base particles. The charge-controlling agent includes metal-containing azo dyes, metal naphthenates, metal alkylsalicylates, fatty acid soap and resin acid soap. Preferably, the content of the charge-controlling agent is from 0.1 parts by weight to 10 parts by weight relative to 100 parts by weight of the binder resin, more preferably from 0.5 parts by weight to 8 parts by weight. When the content is smaller than 0.1 parts by weight, then the charge-controlling agent could not exhibit its function and when larger than 10 parts by weight, then the agent could not be uniformly dispersed in the binder resin.

Production Method:

A colorant, a binder resin and other additives are homogeneously mixed by the use of a dry blender, a super mixer or a ball mill to give a mixture. The resulting mixture is uniformly melt-kneaded by the use of a kneading device such as a Banbury mixer, a roll and a single-screw or double-screw extrusion kneader, and then cooled to give a kneaded mixture. Next, the resulting mixture is ground, and optionally classified to give toner base particles. Further, the external additive is added to the thus-obtained toner base particles by the use of a super mixer or a ball mill to obtain a toner.

### EXAMPLES

The invention is described concretely with reference to the following Examples and Comparative Examples. Not overstepping the scope and the spirit thereof, the invention should not be limited to the Examples.

### Production Example of Toner Base Particles

100 parts by weight of a polyester resin obtained through polycondensation of monomers of bisphenol A propylene oxide, and terephthalic acid or trimellitic anhydride, 5.0 parts by weight of copper phthalocyanine (Pigment Blue 15), and 2.0 parts by weight of a charge-controlling agent, zinc salicylate (Bontron E84 manufactured by Orient Chemical Industry Co.) were uniformly mixed in a super mixer to obtain a mixture. The mixture was kneaded under heating in a double-screw extruder, and then cooled to obtain a kneaded mixture. The mixture was roughly ground in a cutting mill and then finely ground in an ultrasonic jet mill, and thereafter classified through a classifier set for removing fine particles not larger than 5 μm to obtain toner base particles. Thus-obtained toner base particles have the particle size distributed within a range of from 3 μm to 16 μm, and the average particle size thereof was 8.0 μm.

### Production Example of Aluminum Oxide-Silicon Dioxide Mixed Oxide

An aluminum oxide-silicon dioxide mixed oxide was produced according to a thermal decomposition method.

### Production Example of Toner

An external additive (A1 to J1) was added to the toner base particles produced according to the method as above, based on the composition and the amount indicated in Table 1, and mixed in a super mixer to produce a toner. Based on Table 2, external additives of A1 to F1 were used in producing the toners in Examples 1 to 6, and external additives of G1 to K1 were used in producing the toners in Comparative Examples 1 to 5.

TABLE 1

| | Silica | | Aluminum Oxide-Silicon | |
|---|---|---|---|---|
| | average | amount | Dioxide Mixed Oxide | |
| External | particle | added | average particle | amount added |
| Additive | size (nm) | (wt.pt.) | size (nm) | (wt.pt.) |
| A1 | 40 | 1.5 | 20 | 0.60 |
| B1 | 90 | 3.0 | 24 | 0.70 |
| C1 | 60 | 2.0 | 14 | 0.30 |
| D1 | 60 | 2.0 | 20 | 0.08 |
| E1 | 60 | 3.3 | 24 | 0.70 |
| F1 | 40 | 0.4 | 20 | 0.60 |
| G1 | 30 | 1.0 | 20 | 0.60 |
| H1 | 40 | 1.5 | 30 | 1.00 |
| I1 | — | 0.0 | 24 | 0.70 |
| J1 | 60 | 2.0 | — | 0.00 |
| K1 | 60 | 1.5 | 20 | 2.20 |

In Example 1, 1.5 parts by weight of silica (average particle size 40 nm) and 0.60 parts by weight of aluminum oxide-silicon dioxide mixed oxide (average particle size 20 nm) were externally added to 100 parts by weight of the toner base particle produced according to the method as above to produce the toner.

Example 2 is the same as Example 1, except that 3.0 parts by weight of silica (average particle size 90 nm) and 0.70 parts by weight of aluminum oxide-silicon dioxide mixed oxide (average particle size 24 nm) were externally added in place of externally adding 1.5 parts by weight of silica (average particle size 40 nm) and 0.60 parts by weight of aluminum oxide-silicon dioxide mixed oxide (average particle size 20 nm).

Example 3 is the same as Example 1, except that 2.0 parts by weight of silica (average particle size 60 nm) and 0.30 parts by weight of aluminum oxide-silicon dioxide mixed oxide (average particle size 14 nm) were externally added in place of externally adding 1.5 parts by weight of silica (average particle size 40 nm) and 0.60 parts by weight of aluminum oxide-silicon dioxide mixed oxide (average particle size 20 nm).

Example 4 is the same as Example 3, except that 0.08 parts by weight of aluminum oxide-silicon dioxide mixed oxide (average particle size 20 nm) was externally added in place of externally adding 0.30 parts by weight of aluminum oxide-silicon dioxide mixed oxide (average particle size 14 nm).

Example 5 is the same as Example 2, except that 3.3 parts by weight of silica (average particle size 60 nm) was externally added in place of externally adding 3.0 parts by weight of silica (average particle size 90 nm).

Example 6 is the same as Example 1, except that 0.4 parts by weight of silica (average particle size 40 nm) was externally added in place of externally adding 1.5 parts by weight of silica (average particle size 40 nm).

Comparative Example 1 is the same as Example 1, except that 1.0 part by weight of silica (average particle size 30 nm) was externally added in place of externally adding 1.5 parts by weight of silica (average particle size 40 nm).

Comparative Example 2 is the same as Example 1, except that 1.00 part by weight of aluminum oxide-silicon dioxide mixed oxide (average particle size 30 nm) was externally added in place of externally adding 0.60 parts by weight of aluminum oxide-silicon dioxide mixed oxide (average particle size 20 nm).

Comparative Example 3 is the same as Example 2, except no silica was externally added.

Comparative Example 4 is the same as Example 3, except no aluminum oxide-silicon dioxide mixed oxide was externally added.

Comparative Example 5 is the same as Example 1, except that 1.5 parts by weight of silica (average particle size 60 nm) and 2.20 part by weight of aluminum oxide-silicon dioxide mixed oxide (average particle size 20 nm) were externally added in place of externally adding 1.5 parts by weight of silica (average particle size 40 nm) and 0.60 parts by weight of aluminum oxide-silicon dioxide mixed oxide (average particle size 20 nm).

Evaluation Method:

Machine for Evaluation:

For evaluating the toner in the invention, a digital duplicator (AR-C260 manufactured by Sharp K. K.) was used.

In Examples 1 to 6 and Comparative Examples 1 to 5, the toners produced were evaluated in point of the image density uniformity, the background fog and the charge amount according to the methods mentioned below. Briefly, the toner produced according to the method as above was evaluated according to the methods mentioned below, and the results are shown in Table 2. For the initial evaluation, an empty toner cartridge is filled with the toner and then an evaluation according to the methods mentioned below is conducted. For the evaluation after 10000 sheets, an image was first printed on 10000 sheets in the test machine as above, and then the samples were evaluated according to the methods mentioned below.

“A”, “B” and“C” mentioned below for evaluating the tested samples are in Table 1, indicating the test results of the samples. “A” means good samples; “B” means practicable samples; and “C” means impracticable samples.

Image Density Uniformity:

Using the test machine as above, a solid image of 3 cm×3 cm was printed on transfer paper. Using a reflection densitometer (RD918 manufactured by Macbeth Co.), the density of the solid image was measured at three-parts, the center and both edges of the solid image. The difference between the highest reflection density and the lowest reflection density of the thus-measured reflection density is referred to as a density difference, and according to the following standards, the samples were evaluated in point of the image density uniformity thereof.
A: The density difference is 0.15 or less.
B: The density difference is more than 0.15 and equal to 0.25 or less.
C: The density difference is more than 0.25.

Background Fog:

Using the test machine, an image was printed on transfer paper. Then, using a reflection densitometer (RD918 manufactured by Macbeth Co.), the reflection density of the white background part of the transfer paper was measured before and after printing thereon. From the difference between the reflection density data thus measured, the samples were evaluated in point of the background fog resistance according to the following standards.
A: The reflection density difference is 0.005 or less.
B: The reflection density difference is larger than 0.005 and smaller than 0.009.
C: The reflection density difference is 0.009 or more.

Charge Amount:

The charge amount of the toner was measured with a charge amount meter (Model 210 HS-2 manufactured by TREK Co.).

TABLE 2

| | | Initial | | | After 10000 Sheets | | | |
|---|---|---|---|---|---|---|---|---|
| | | Charge | Image | | Charge | Image | | |
| | External | Amount | Density | Background | amount | density | Background | Total |
| | Additive | (μ/G) | Uniformity | fog | (μ/g) | uniformity | Fog | Evaluation |
| Example 1 | A1 | −25 | A | A | −24 | A | A | AA |
| Example 2 | B1 | −22 | A | A | −23 | A | A | AA |
| Example 3 | C1 | −23 | A | A | −21 | A | A | AA |
| Example 4 | D1 | −20 | B | A | −21 | B | A | A |
| Example 5 | E1 | −24 | A | B | −23 | A | B | A |
| Example 6 | F1 | −26 | A | A | −19 | B | B | A |
| Comparative | G1 | −28 | A | A | −14 | C | C | C |
| Example 1 | | | | | | | | |
| Comparative | H1 | −19 | B | C | −17 | B | C | C |
| Example 2 | | | | | | | | |
| Comparative | I1 | −24 | B | A | −13 | C | C | C |
| Example 3 | | | | | | | | |
| Comparative | J1 | −15 | C | C | −12 | C | C | C |
| Example 4 | | | | | | | | |
| Comparative | K1 | −16 | B | C | −13 | C | C | C |
| Example 5 | | | | | | | | |

As is known from Table 2, the toner that comprises, as an external additive thereto, silica having an average particle size of from 40 nm to 200 nm, and an aluminum oxide-silicon dioxide mixed oxide having an average particle size of from 5 nm to 25 nm was still good in point of the charge amount, the image density uniformity and the background fog resistance even after used for printing 10000 sheets.

However, when the particle size of silica is smaller than the defined range (Comparative Example 1), then the external additive could not be satisfactorily prevented from being buried in the toner particles. Therefore, the toner was good in point of the charge amount, the image density uniformity and the background fog resistance in the initial stage, but after used for printing 10000 sheets, the toner could not keep its properties, or that is, the toner lacks long-term stability. When aluminum oxide-silicon dioxide mixed oxide is larger than the defined range (Comparative Example 2), then the surface resistivity of the toner could not be sufficiently controlled. Therefore, the toner was not good in point of the charge amount, the image density uniformity and the background fog resistance. When no silica is added (Comparative Example 3), then the toner also lacks long-term stability, like in Comparative Example 1. When aluminum oxide-silicon dioxide mixed oxide is not added (Comparative Example 4), then the surface resistivity of the toner could not be controlled, and the toner was not good in point of the charge amount, the image density uniformity and the background fog resistance. When the amount of aluminum oxide-silicon dioxide mixed oxide added is larger than the defined range (Comparative Example 5), then the surface resistivity of the toner could not be sufficiently controlled, and therefore the toner was not good in point of the charge amount, the image density uniformity and the background fog resistance.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

1. A toner comprising:
a toner base particle containing at least a colorant and a binder resin;
silica having an average particle size of from 40 nm to 200 nm; and
an aluminum oxide-silicon dioxide mixed oxide having an average particle size of from 5 nm to 25 nm,
wherein the silica and the aluminum oxide-silicon dioxide mixed oxide are externally added to the toner base particle.

2. The toner of claim 1, wherein the aluminum oxide-silicon dioxide mixed oxide is prepared according to a thermal decomposition method.

3. The toner of claim 1, wherein the aluminum oxide-silicon dioxide mixed oxide is externally added to the toner base particle so that an amount of the aluminum oxide-silicon dioxide mixed oxide is from 0.1 parts by weight to 2 parts by weight relative to 100 parts by weight of the toner base particle.

4. The toner of claim 1, wherein the silica is externally added to the toner base particle so that an amount of the silica is from 0.5 parts by weight to 3 parts by weight relative to 100 parts by weight of the toner base particle.

5. The toner of claim 1, wherein the proportion of aluminum oxide in the aluminum oxide-silicon dioxide mixed oxide is from 50% to 70%.
